(19) United States
(12) Patent Application Publication
(10) Pub. No.: US 2006/0093277 A1
(43) Pub. Date: May 4, 2006

(54) Combination optical fiber and electrical connecter

(76) Inventor: Paul M. Mulligan, Yorkville, IL (US)

Correspondence Address: Frank L. Hart;Attorney at Law, 8911 S. 73rd East Ave., Tulsa, OK, 74133, US

(21) Appl. No.: 10/977,152

(22) Filed: Oct. 29, 2004

(51) Int. Cl. G02B 6/38

(52) U.S. Cl. 385/75

(57) ABSTRACT

A combination optical fiber and electrical connector wherein electricity is passed from an electrical wire, through a ferrule of the optical fiber element. The ferrule is a single element of tubular construction open at opposed ends. The terminal end of the ferrule comprises the male plug of the connector. By so construction the connector, a more compact and simple connector can be manufactured.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

The subject invention relates to the construction of a connector. More particularly, the subject invention relates to a combination optical fiber and electrical connector.

2. Description of Related Art Including Information Disclosed Under 37 CFR 1.97 and 1.98

In the manufacture of modern machinery, instruments, and other electrical and electronic equipment, there is an ever increasing demand for smaller and more compact elements and parts. One area of construction that has been particularly troublesome is in the area of optical and electrical equipment.

Most equipment which sends and receives information uses fiber optics technology. Such optical equipment substantially always also relies on electrical connections for supplying power or control signals. Therefore, there has been a great amount of work in trying to construct combination optical and electrical connectors which are of simple construction, easy to manufacture, compact, and efficiently utilize our natural resources.

One example of heretofore attempts to construct a combination optical fiber and electrical connector is U.S. Pat. No. 5,461,688, “Fiber Optical Connector with Electrical Contact”, which issued Oct. 24, 1995 to Hsin Lee and is assigned to Augat Inc., from an application filed Sep. 2, 1994. That patent uses a special coaxial fiber and is of complex construction with a two piece ferrule. In another example of heretofore attempts to construct a combination optical fiber and electrical connector is U.S. Pat. No. 4,896,939, “Hybrid Fiber Optical/Electrical Cable and Connector”, which issued Jan. 30, 1990, to Donald G. O'Brien and is assigned to D. G. O'Brien, Inc., from an application filed Oct. 30, 1987. That patent discloses a tri-axial cable for underwater use. The optical fiber is surrounded by the inner conductor.

None of the references studied utilize a single element metal ferrule connected to the optical fiber element for maintaining the optical fiber element and for passing electrical current. The elimination of parts by this construction offers the designer of a combination connector a unique and unobvious way to form a more compact connector.

The subject invention is directed to overcome one or more of the heretofore problems associated with combination connectors.

### BRIEF SUMMARY OF THE INVENTION

In one aspect of the invention a combination optical fiber and electrical connector has a connector body, at least one optical fiber element, at least one electrical wire, and a metal ferrule. The metal ferrule surrounds and is connected to the optical fiber element. The metal ferrule is a single element of tubular construction open at opposed ends. Means is provided for connecting the connector body, the metal ferrule, and the wire, and is adapted for passing electrical current from the wire to and through the ferrule and for passing light through the ferrule.

### BRIEF DESCRIPTION OF THE SEVERAL VIEWS OF THE DRAWING(S)

FIG. 1 is a top view of a male connector of this invention;

FIG. 2 is a partial sectional view taken along lines II-II of the connector of this invention;

FIG. 3 is a sectional view taken along lines III-III of FIG. 2; and

FIG. 4 is a sectional view taken along lines IV-IV of FIG. 3.

### DETAILED DESCRIPTION OF THE INVENTION

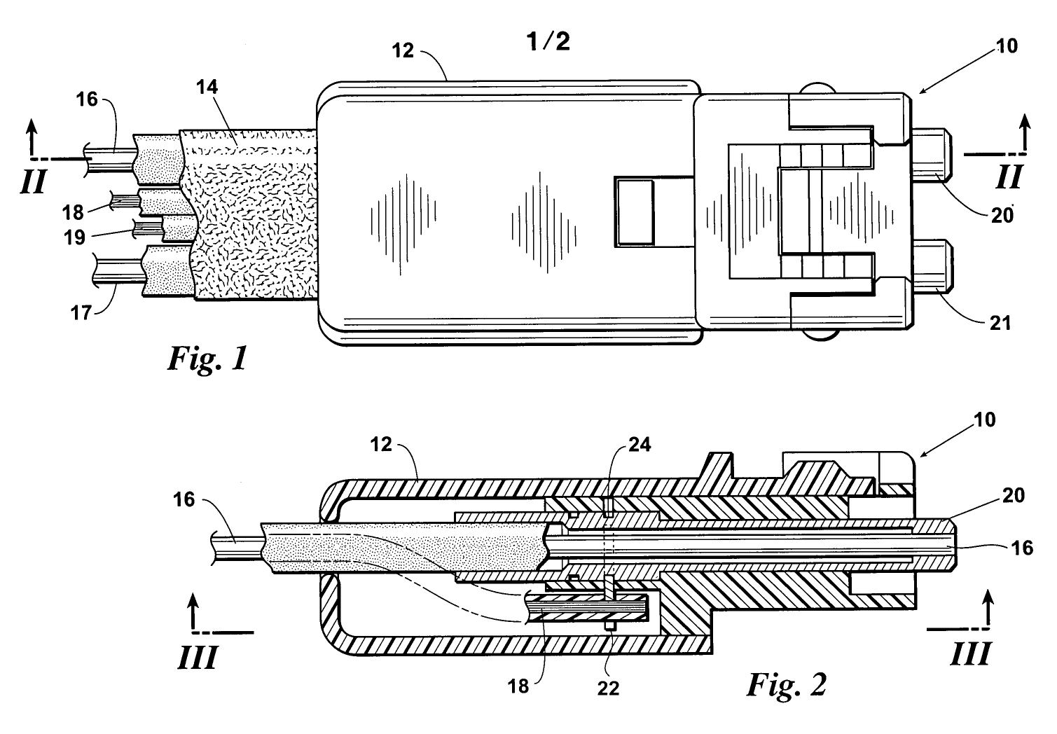

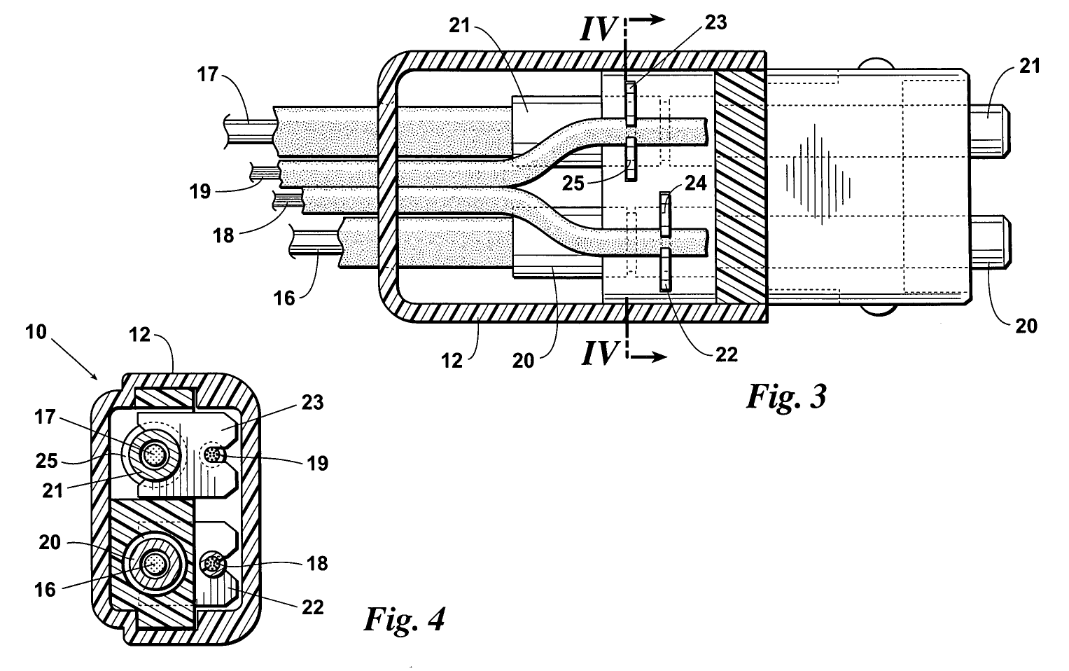

Referring to FIG. 1, the connector 10 of this invention has a body 12 and an example combination cable 14 entering the body 12. The example combination cable 14 is here shown with two separate fiber optical elements 16,17, two separate electrical wires 18,19, and, as better seen in FIGS. 2 and 3, a separate metal ferrule 20,21 surrounding a respective optical fiber element 16,17 and extending beyond the connector body 12 for insertion into a similarly constructed female connector.

It should be understood that, for purposes of simplicity, a dual connector is shown. However, a single optical/electrical connector can be constructed as shown in FIG. 2 without reference to section line II-II of FIG. 1. Likewise, only a male portion of a connector is shown for it would be obvious to one skilled in the art studying this invention to similarly construct the associated female connector.

For purposes of convenience and understanding, the optical fiber element can be a single strand of plastic or glass or can consist of a plurality plastic or glass optical fiber elements 16 forming an optical cable to be inserted within a separate ferrule 20.

Referring to FIGS. 2-4, a metal ferrule 20,21 is connected to a respective optical fiber element 16,17. Each ferrule 20, 21 is a single element of tubular construction open at opposed ends. The terminal end of each ferrule 20,21 comprises the male plug of the connector 10. As is known in the art, the ferrules 20,21 of optical connectors are friction fit about their respective optical fiber element 16,17 and connected by some means to a body 12, preferably a plastic body, of the connector 10.

Means 22,23 is provided for connecting the connector body 10, the metal ferrules 20,21, and the electrical wires 18,19. In the preferred embodiment shown, each Means 22,23 is a metal clip each connected to the connector body 10 and inserted into a groove 24,25 formed on the periphery of a respective ferrule 20,21. A respective wire 18,19 is connected to a respective metal clip 22,23 for passing electrical current from the wire to and through the ferrule.

It should be understood that other means 22,23 can be provided for connecting the body 10, the ferrules 20,21 and the electrical wires 18,19 without departing from this invention. The ferrules 20 and associated optical fiber element 16,17 could be connected to the body 10 by other means such as a snap action finger in the plastic body 10, by insert molding the ferrule, by press fit, etc. The electrical connection between the ferrules 20,21 and the wires 18,19 can be by other means such as welding one to the other or by a crimped sleeve extending about the ferrules.

The subject invention has been described as having at least one optical fiber element 16 or combination cable comprised of a plurality of optical fiber elements, at least one electrical wire 18, and a metal ferrule 20 about the optical fiber element 16. However, since the problem being solved by this invention is most uniquely adapted to form a compact connecter having a plurality of separate optical fiber elements 16,17, electrical wires 18,19 ferrules 20,21, most of the written description herein is directed to a plurality of elements for exemplary purposes in solving the pressing problem facing the industry.

It should also be understood that the subject invention of using the single element ferrule for passing electrical current is shown associated with a SMI type connector design, but this invention can be utilized on many other type designs such as Duplex HP, SC Duplex, LC Duplex, BCD, FDD1, MPT, ESCON, etc. The construction of this invention can also be used with any combination type cable arrangement, such as ribbon, flat, separate, round, etc.

Other aspects, objects, and advantages of this invention can be obtained from a study of the drawings, the disclosure and the appended claims.

1. A combination optical fiber and electrical connector, comprising:
a connector body;
at least one optical fiber element;
at least one electrical wire;
a metal ferrule surrounding and being connected to the optical fiber element, said metal ferrule being a single element of tubular construction having a chamber open at opposed ends said ferrule having a peripherally extending groove; and
a metal clip being connected to the connector body, extending into the peripheral groove of the ferrule and being connected in electrical contact with the electrical wire for passing electrical current through the ferrule while passing optical fibers through the ferrule chamber.

2. (canceled)

3. A connector, as set forth in claim 1, wherein the optical fiber element is formed of a plurality of optical fibers.

4. A connector, as set forth in claim 1, wherein their are a plurality of optical fiber elements, a plurality of metal ferrules, a plurality of metal clips and at least one of said metal ferrules being connected to an electric wire thereby forming a pluraltiy of optical fiber elements and an electrical connection connected to the connector body.
